(19) United States
(12) Patent Application Publication
(10) Pub. No.: US 2018/0053608 A1
(43) Pub. Date: Feb. 22, 2018

(54) KEYBOARD DEVICE AND SCISSORS CONNECTING MEMBER THEREOF

(71) Applicant: PRIMAX ELECTRONICS LTD., Taipei (TW)

(72) Inventors: Chun-Yuan Liu, Taipei (TW); Tsu-Yi Chen, Taipei (TW)

(21) Appl. No.: 15/331,482

(22) Filed: Oct. 21, 2016

(30) Foreign Application Priority Data
Aug. 19, 2016 (TW) 105126578

(51) Int. Cl. H01H 13/14; H01H 13/70

(52) U.S. Cl. CPC H01H 13/14; H01H 13/70

(57) ABSTRACT

A keyboard device is provided. The keyboard device includes a button bottom plate, buttons, and a thin-film circuit board disposed between the button bottom plate and the buttons. The button includes a button cap and a scissors connecting member connected between the button bottom plate and the button cap. The scissors connecting member includes an outer frame and an inner frame. The inner frame includes a frame body and a rotating shaft that is connected to the frame body and extends out of the frame body. The inner frame is pivotally connected to the outer frame by means of the rotating shaft, and the rotating shaft and the frame body are made of different materials, respectively.

### FIELD OF THE INVENTION

The present invention relates to the field of input devices, and in particular, to a keyboard device and a scissors connecting member thereof.

### BACKGROUND OF THE INVENTION

Conventional peripheral input devices of a computer include a mouse device, a keyboard device, a trackball device, and the like. The keyboard device can be used by a user to directly enter a letter or a symbol into a computer, and therefore a great deal of attention is paid thereto.

First, a structure and functions of a conventional keyboard device 1 are described. Referring to FIG. 1 to FIG. 3, FIG. 1 is a structural schematic diagram of an appearance of a conventional keyboard device. FIG. 2 is a three-dimensional, exploded view of a part of the keyboard device shown in FIG. 1 from a perspective. FIG. 3 is a three-dimensional, exploded view of a part of the keyboard device shown in FIG. 1 from another perspective. To describe more clearly, only one single button 10 and relevant elements are drawn in FIG. 2 and FIG. 3. A conventional keyboard device 1 includes a plurality of buttons 10, a button bottom plate 11, and a thin-film circuit board 12. A plurality of thin-film switches 121 corresponding to the plurality of buttons 10 is provided on the thin-film circuit board 12. The button 10 includes a button cap 101, a scissors connecting member 102, and an elastic body 103. The scissors connecting member 102 is connected between the button cap 101 and the button bottom plate 11, and includes an outer frame 1021 and an inner frame 1022. The inner frame 1022 is pivotally connected to the outer frame 1021 by means of a rotating shaft 10221 of the inner frame 1022. Therefore, the outer frame 1021 and the inner frame 1022 are capable of swinging relative to each other. Besides, the elastic body 103 is disposed between the button cap 101 and the button bottom plate 11, and includes an abutting section 1031.

When a button cap 101 of any button 10 is pressed to move downwards relative to the button bottom plate 11, the outer frame 1021 and the inner frame 1022 of the scissors connecting member 102 change from a retractable status to a superimposed status. The button cap 101 that moves downwards extrudes the elastic body 103, such that the abutting section 1031 of the elastic body 103 abuts against and triggers the corresponding thin-film switch 121, so as to enable the keyboard device 1 to generate a corresponding button signal. When the button 10 is no longer pressed, the button cap 101 moves upwards relative to the button bottom plate 11 under the action of an elastic force of the elastic body 103. In this case, the outer frame 1021 and the inner frame 1022 change from the superimposed status to the retractable status, and the button cap 101 may recover to the original position.

However, because the existing keyboard devices 1 are developing towards lightness and thinness, the thickness of the button 10 also needs to be reduced, so as to meet the requirement of thinness of a keyboard device 1. However, because the scissors connecting member 102 of the button 10 is made of a plastic material, the overall thickness can only be reduced to 0.8 mm at most. Otherwise, the structural strength of the button 10 may be insufficient, and the stability of support of the button cap 101 may be influenced.

Therefore, an improved keyboard device has been provided. In a button of the improved keyboard device, an outer frame of a scissors connecting member thereof is made of a metal material, and therefore, a relatively great structural strength can be provided, such that the overall thickness of the scissors connecting member can be reduced below 0.8 mm. However, it needs to be specified that, in the existing processing, it is not easy to form a rotating shaft that is of an inner frame of the scissors connecting member and configured for being pivotally connected to an outer frame by using a metal. Therefore, the existing inner frames are still made of a plastic material. Accordingly, it is not possible to improve the structural strength by means of a metal material. As a result, the degree by which the overall thickness of the scissors connecting member can be reduced remains limited.

It can be known according to the above description that there is still a bottle neck in the process of thinness of a keyboard device, and there is still room for improvement of a conventional keyboard device.

### SUMMARY OF THE INVENTION

An object of the present invention is to provide a scissors connecting member. In particular, the present invention relates to a scissors connecting member whose inner frame is made of a composite material, so as to improve an overall structural strength of the scissors connecting member.

Another object of the present invention is to provide an input device. In particular, the present invention relates to a keyboard device having the scissors connecting member, so as to develop towards thinness.

In a preferred embodiment, the present invention provides a keyboard device, including:

a button bottom plate; and

a button, disposed above the button bottom plate, and including:

a button cap; and

a scissors connecting member, connected between the button bottom plate and the button cap, such that the button cap moves up and down relative to the button bottom plate, where the scissors connecting member includes:

an outer frame, including at least one shaft hole; and

an inner frame, including a frame body and a plurality of rotating shafts, each one of the plurality of rotating shafts being connected to the frame body and extending out of the frame body, and at least one of the plurality of rotating shafts passing through at least one shaft hole of the outer frame, such that the inner frame is pivotally connected to the outer frame, where the frame body and at least one of the plurality of rotating shafts are made of different materials, respectively.

In a preferred embodiment, the present invention also provides a scissors connecting member, applicable to a button, including:

an outer frame, including at least one shaft hole; and

an inner frame, including a frame body and a plurality of rotating shafts, each one of the plurality of rotating shafts being connected to the frame body and extending out of the frame body, and at least one of the plurality of rotating shafts passing through at least one shaft hole of the outer frame, such that the inner frame is pivotally connected to the outer frame, where the frame body and at least one of the plurality of rotating shafts are made of different materials, respectively.

### BRIEF DESCRIPTION OF THE DRAWINGS

FIG. 1 is a structural schematic diagram of an appearance of a conventional keyboard device;

FIG. 2 is a three-dimensional, exploded view of a part of the keyboard device shown in FIG. 1 from a perspective;

FIG. 3 is a three-dimensional, exploded view of a part of the keyboard device shown in FIG. 1 from another perspective;

FIG. 4 is a structural schematic diagram of an appearance of a keyboard device of the present invention;

FIG. 5 is a three-dimensional, exploded view of a part of the keyboard device shown in FIG. 4 from a perspective;

FIG. 6 is a three-dimensional, exploded view of a part of the keyboard device shown in FIG. 4 from another perspective;

FIG. 7 is a structural schematic diagram of an outer frame of a scissors connecting member shown in FIG. 4; and

FIG. 8 is a structural schematic diagram of an inner frame of a scissors connecting member shown in FIG. 4.

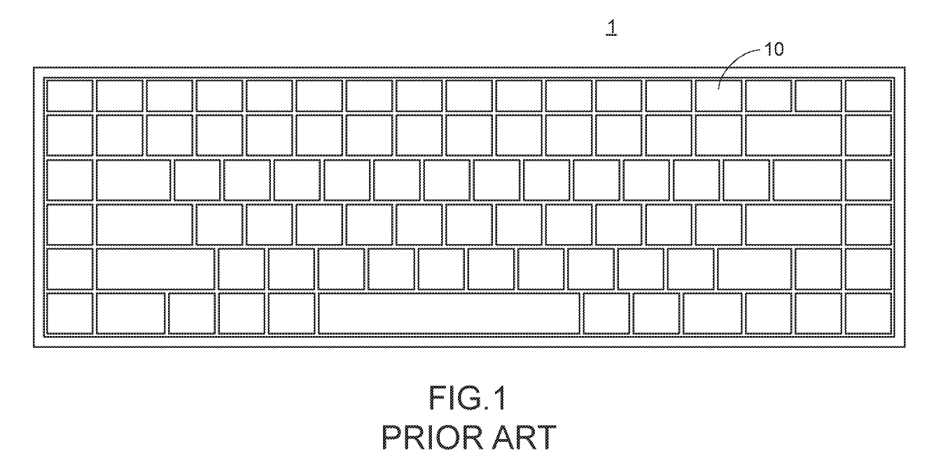

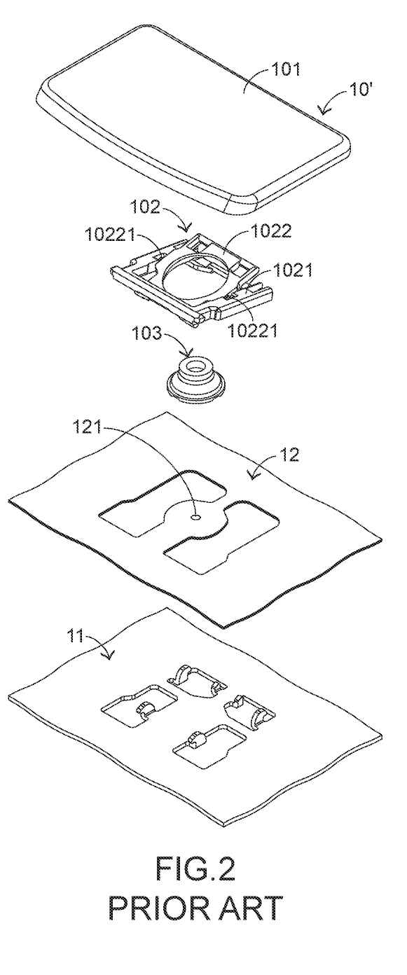

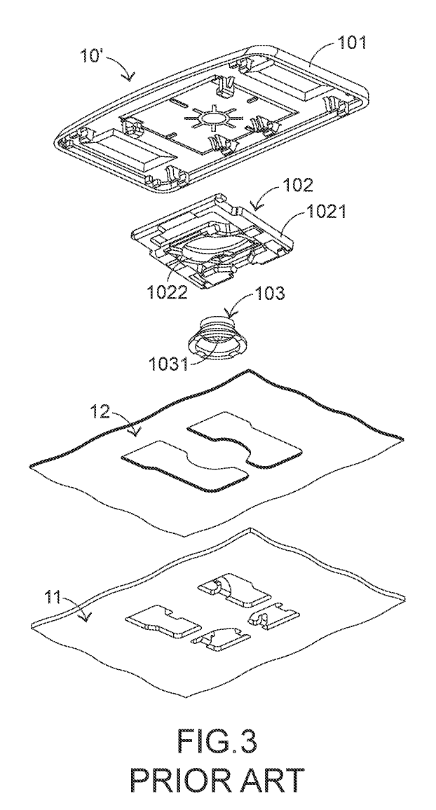

### DETAILED DESCRIPTION OF THE PREFERRED EMBODIMENT

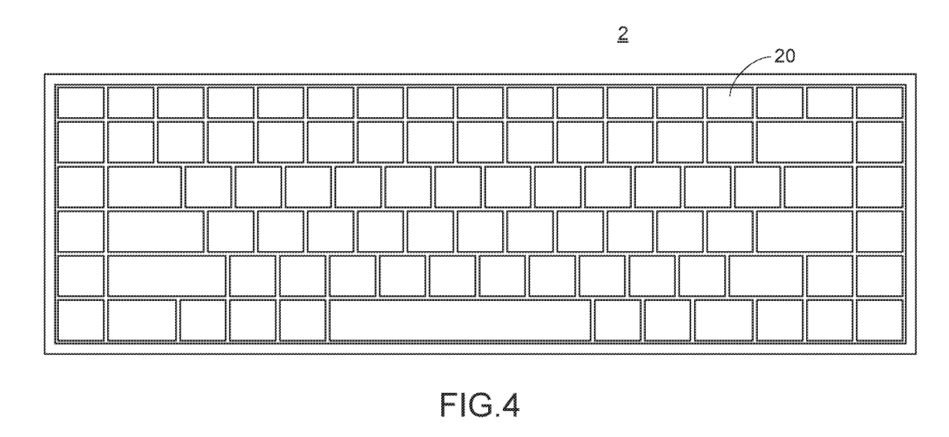

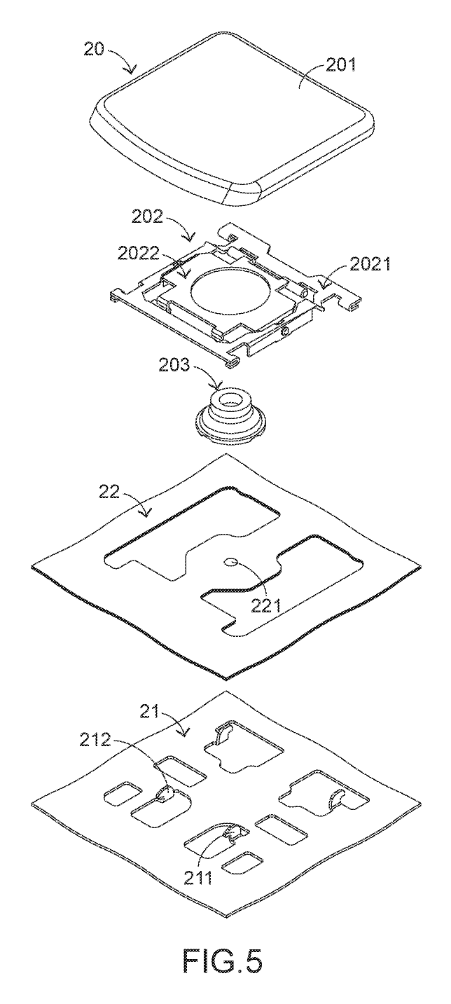

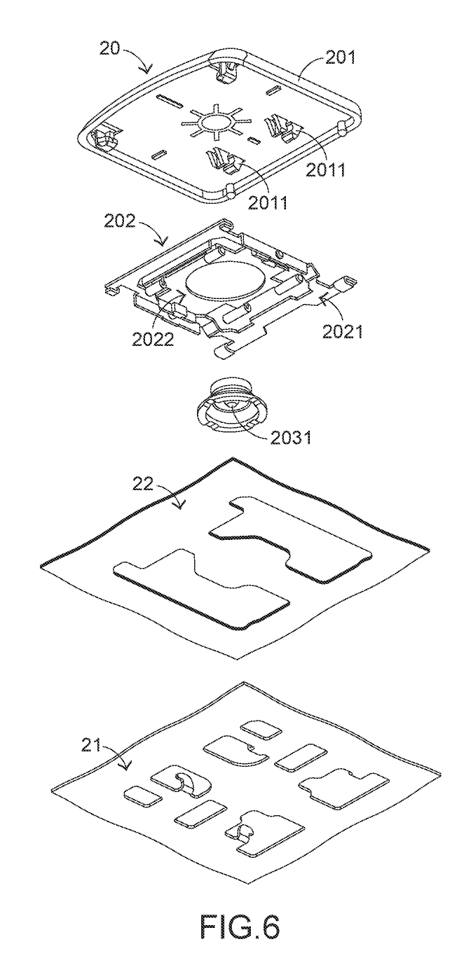

Referring to FIG. 4 to FIG. 6, FIG. 4 is a structural schematic diagram of a keyboard device of the present invention. FIG. 5 is a three-dimensional, exploded view of a part of the keyboard device shown in FIG. 4 from a perspective. FIG. 6 is a three-dimensional, exploded view of a part of the keyboard device shown in FIG. 4 from another perspective. To describe more clearly, only one single button 20 and relevant elements are drawn in FIG. 5 and FIG. 6. The keyboard device 2 includes a plurality of buttons 20, a button bottom plate 21, and a thin-film circuit board 22 disposed between the buttons 20 and the button bottom plate 21. The buttons 20 can be classified into common buttons, numeral buttons, functional buttons, and the like. The buttons are respectively provided for being pressed by fingers of a user, to enable the keyboard device 2 to generate corresponding button signals for a computer, such that the computer executes corresponding functions. For example, the common buttons are configured to input symbols such as English letters, the numeral buttons are configured to input numerals, and the functional buttons are configured to provide various shortcut functions, such as F1 to F12.

Further, a plurality of thin-film switches 221 respectively corresponding to the buttons 20 is provided on the thin-film circuit board 22. Each button 20 includes a button cap 201, a scissors connecting member 202, and an elastic body 203. Each scissors connecting member 202 is connected between the corresponding button cap 201 and the button bottom plate 21, and is configured to enable the corresponding button cap 201 to move up and down relative to the button bottom plate 21. The elastic body 203 is disposed on the corresponding thin-film switch 221 and passes through the corresponding scissors connecting member 202 to contact the button cap 201, and the elastic body 203 is provided with an abutting section 2031.

When a button cap 201 of any button 20 is pressed to move downwards relative to the button bottom plate 21, the button cap 201 may extrude the elastic body 203, such that the abutting section 2031 of the elastic body 203 abuts against and trigger the corresponding thin-film switch 221, to further enable the keyboard device 2 to output a corresponding button signal. When the button cap 201 of the button 20 is no longer pressed, the button cap 201 moves upwards relative to the button bottom plate 21 under the action of an elastic force that is generated after the elastic body 203 is extruded, so as to recover to the original position.

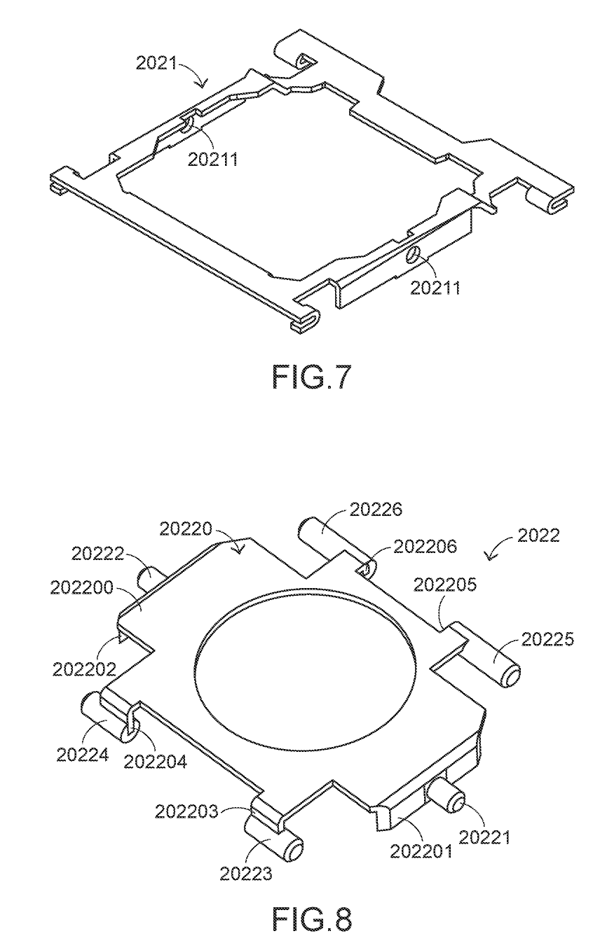

Referring to FIG. 7 and FIG. 8, FIG. 7 is a structural schematic diagram of an outer frame of a scissors connecting member shown in FIG. 4. FIG. 8 is a structural schematic diagram of an inner frame of a scissors connecting member shown in FIG. 4. Each scissors connecting member 202 includes an outer frame 2021 and an inner frame 2022. The outer frame 2021 includes a first shaft hole 20211 and a second shaft hole 20212. The inner frame 2022 includes a frame body 20220, a first rotating shaft 20221 corresponding to the first shaft hole 20211, and a second rotating shaft 20222 corresponding to the second shaft hole 20212. The first rotating shaft 20221 is connected between two sides of the frame body 20220, and extends out of the frame body 20220, to pass through the first shaft hole 20211. The second rotating shaft 20222 is connected between two sides of the frame body 20220 and extends out of the frame body 20220, to pass through the second shaft hole 20212. Therefore, the outer frame 2021 and the inner frame 2022 are pivotally connected, and are capable of swinging relative to each other.

In the preferred embodiment, the inner frame 2022 of each scissors connecting member 202 further includes a third rotating shaft 20223 and a fourth rotating shaft 20224. The button bottom plate 21 includes a plurality of first bottom plate hooks 211 and a plurality of second bottom plate hooks 212 that extend upwards and pass through the thin-film circuit board 22. Two ends of the third rotating shaft 20223 are connected to a side of the frame body 20220 and a corresponding first bottom plate hook 211, respectively. Two ends of the fourth rotating shaft 20224 are connected to the side of the frame body 20220 and a corresponding second bottom plate hook 212, respectively.

Further, in the preferred embodiment, the inner frame 2022 of each scissors connecting member 202 further includes a fifth rotating shaft 20225 and a sixth rotating shaft 20226, and each button cap 201 includes a first button cap clamp 2011 and a second button cap clamp 2012. Two ends of the fifth rotating shaft 20225 are connected to an other side of the frame body 20220 and a corresponding first button cap clamp 2011, respectively. Two ends of the sixth rotating shaft 20226 are connected to the other side of the frame body 20220 and a corresponding second button cap clamp 2012. Therefore, when a button cap 201 of any button is pressed to move downwards relative to the button bottom plate 21, the scissors connecting member 202 changes from a retractable status to a superimposed status. When the button cap 201 of the button is no longer pressed and recovers to the original position under the action of an elastic force generated by the elastic body, the scissors connecting member 202 changes from the superimposed status to the retractable status.

To improve the structural strength of the button 20 and the stability of support of the button cap 201, in the present invention, the materials of the first rotating shaft 20221 to the sixth rotating shaft 20226 in the inner frame 2022 of the scissors connecting member 202 are separately different from that of the frame body 20220. Specifically, in the preferred embodiment, the outer frame 2021 and the frame body 20220 of the inner frame 2022 of the scissors connecting member 202 are made of a metal material, and the first rotating shaft 20221 to the sixth rotating shaft 20226 of the inner frame 2022 are made of a plastic material. The first rotating shaft 20221 to the sixth rotating shaft 20226 may be formed by means of an in-mold injection molding process, and are connected to the frame body 20220. The in-mold injection technology is well known by a person skilled in the art, and therefore is not described in detail herein. It needs to be specified that the design can resolve the problem of insufficient structural strength caused by the use of only a plastic material for the conventional inner frame 2022 since it is not easy to form the rotating shafts 20221 to 20226 by using a metal by means of the existing processing.

Besides, the frame body 20220 of the inner frame 2022 is not limited to the form of plate. In the preferred embodiment, the frame body 20220 includes a plate section 202200 and a first bent section 202201 to a sixth bent section 202206 that are bent downwards from and extend out of a periphery of the plate section 202200, the plate section 202200 and the first to sixth bent sections 202201 to 202206 being formed by a same metal sheet. The first bent section 202201 to the sixth bent section 202206 are configured for being connected to the first rotating shaft 20221 to the sixth rotating shaft 20226, respectively. The frame body 20220 may be formed by means of a sheet metal manufacturing process. The sheet metal manufacturing process is well known by a person skilled in the art, and therefore is not described in detail herein. It needs to be specified that the object of designing the first bent section 202201 to the sixth bent section 202206 that are bent downwards from and extend out of the periphery of the plate section 202200 in the present invention is to enable the frame body 20220 to have a good moment of inertia, so as to enable the frame body 20220 to have a relatively great rigidness and structural strength.

In view of the foregoing description, the design of manufacturing the inner frame of the scissors connecting member by using a composite material in the present invention can improve the structural strength of the scissors connecting member, and provides flexibility for reducing the overall thickness of the scissors connecting member, so as to further enable the keyboard device to develop towards thinness. Therefore, the keyboard device and the scissors connecting member thereof in the present invention have a great industrial value.

The above are only the most preferred embodiments of the present invention, and the present invention needs not be limited to the disclosed embodiments. Therefore, all equivalent changes or modifications included within the spirit and scope of the present invention fall within the scope of the claims of the present invention.

What is claimed is:

1. A keyboard device, comprising:
a button bottom plate; and
a button, disposed above the button bottom plate, and comprising:
a button cap; and
a scissors connecting member, connected between the button bottom plate and the button cap, such that the button cap moves up and down relative to the button bottom plate, wherein the scissors connecting member comprises:
an outer frame, comprising at least one shaft hole; and
an inner frame, comprising a frame body and a plurality of rotating shafts, each one of the plurality of rotating shafts being connected to the frame body and extending out of the frame body, and at least one of the plurality of rotating shafts passing through at least one shaft hole of the outer frame, such that the inner frame is pivotally connected to the outer frame, wherein the frame body and at least one of the plurality of rotating shafts are made of different materials, respectively.

2. The keyboard device according to claim 1, wherein the at least one shaft hole comprises a first shaft hole and a second shaft hole, and the plurality of rotating shafts comprises a first rotating shaft and a second rotating shaft, wherein the first rotating shaft is connected between two sides of the frame body and passes through the first shaft hole, and the second rotating shaft is connected between two sides of the frame body and passes through the second shaft hole

3. The keyboard device according to claim 1, wherein the plurality of rotating shafts comprises a fourth rotating shaft, and the button bottom plate comprises a first bottom plate hook and a second bottom plate hook, wherein two ends of the third rotating shaft are connected to a side of the frame body and the first bottom plate hook, respectively, and two ends of the fourth rotating shaft are connected to the side of the frame body and the second bottom plate hook, respectively.

4. The keyboard device according to claim 1, wherein the plurality of rotating shafts comprises a fifth rotating shaft and a sixth rotating shaft, and the button cap comprises a first button cap clamp and a second button cap clamp, wherein two ends of the fifth rotating shaft are connected to a side of the frame body and the first button cap clamp, respectively, and two ends of the sixth rotating shaft are connected to the side of the frame body and the second button cap clamp, respectively.

5. The keyboard device according to claim 1, wherein the frame body is made of a metal material.

6. The keyboard device according to claim 5, wherein the frame body comprises a plate section and at least one bent section that is bent downwards from and extends out of a periphery of the plate section.

7. The keyboard device according to claim 6, wherein at least one of the plurality of rotating shafts is connected to the at least one bent section.

8. The keyboard device according to claim 6, wherein the frame body is formed by means of a sheet metal manufacturing process.

9. The keyboard device according to claim 1, wherein at least one of the plurality of rotating shafts is made of a plastic material.

10. The keyboard device according to claim 9, wherein the at least one of the plurality of rotating shafts is formed by means of an in-mold injection molding process and is connected to the frame body.

11. The keyboard device according to claim 1, wherein the outer frame is made of a metal material.

12. The keyboard device according to claim 11, further comprising a thin-film circuit board, the thin-film circuit board being disposed on the button bottom plate and being provided with a thin-film switch, and the button further comprising an elastic body, the elastic body being disposed on the thin-film switch and passing through the scissors connecting member, so as to contact the button cap, wherein the elastic body is configured to, when being pressed against by the button cap, trigger the thin-film switch and exert an elastic force onto the button cap.

13. A scissors connecting member, applicable to a button, comprising:
an outer frame, comprising at least one shaft hole; and
an inner frame, comprising a frame body and a plurality of rotating shafts, each one of the plurality of rotating shafts being connected to the frame body and extending out of the frame body, and at least one of the plurality of rotating shafts passing through at least one shaft hole of the outer frame, such that the inner frame is pivotally connected to the outer frame, wherein the frame body and at least one of the plurality of rotating shafts are made of different materials, respectively.

14. The scissors connecting member according to claim 13, wherein the frame body is made of a metal material.

15. The scissors connecting member according to claim 14, wherein the frame body comprises a plate section and at least one bent section that is bent downwards from and extends out of a periphery of the plate section.

16. The scissors connecting member according to claim 15, wherein at least one of the plurality of rotating shafts is connected to the at least one bent section.

17. The scissors connecting member according to claim 15, wherein the frame body is formed by means of a sheet metal manufacturing process.

18. The scissors connecting member according to claim 13, wherein at least one of the plurality of rotating shafts is made of a plastic material.

19. The scissors connecting member according to claim 18, wherein the at least one of the plurality of rotating shafts is formed by means of an in-mold injection molding process and is connected to the frame body.

20. The scissors connecting member according to claim 13, wherein the outer frame is made of a metal material.
